(19) United States
(12) Patent Application Publication
(10) Pub. No.: US 2016/0115322 A1
(43) Pub. Date: Apr. 28, 2016

(54) RADIATION-CURABLE COATING COMPOSITION

(71) Applicant: COVESTRO DEUTSCHLAND AG, Leverkusen (DE)

(72) Inventors: Serguei KOSTROMINE, Swisttal-Buschhoven (DE); Joachim PETZOLDT, Monheim (DE); Wieland HOVESTADT, Leichlingen (DE); Eberhard KOCH, Burscheid (DE); Roland KÜNZEL, Leverkusen (DE)

(73) Assignee: Covestro Deutschland AG, Leverkusen (DE)

(21) Appl. No.: 14/897,842

(22) PCT Filed: Jun. 11, 2014
(86) PCT No.: PCT/EP2014/062086

§ 371 Date: Dec. 11, 2015

(30) Foreign Application Priority Data
Jun. 14, 2013 (EP) 13712188.8

(51) Int. Cl. C09D 4/06; C09D 5/00; C08J 7/04

(52) U.S. Cl. CPC C09D 4/06; C08J 7/047; C09D 5/00; C08J 2369/00; C08J 2451/00

(57) ABSTRACT

The present invention relates to a coating composition comprising (a) at least one thermoplastic polymer having a mean molar mass Mw of at least 100 000 g/mol in a content of at least 30% by weight of the solids content of the coating composition, (b) at least one UV-curable reactive diluent in a content of at least 30% by weight of the solids content of the coating composition, (c) at least one photoinitiator in a content of ≧0.1 to ≦10 parts by weight of the solids content of the coating composition, and (d) at least one organic solvent, where the proportion of ethylenically unsaturated groups is at least 3 mol per kg of the solids content of the coating composition. It further relates to a process for producing such coating compositions, to films coated therewith, to the use of such films for production of shaped bodies, to a process for producing shaped bodies having a radiation-cured coating, and to shaped bodies producible by this process. The inventive coatings have excellent solvent stability, and good scratch resistance and pencil hardness.

The present invention relates to a radiation-curable coating composition comprising at least one thermoplastic polymer, a reactive diluent, a photoinitiator and at least one organic solvent, said composition comprising a particular proportion of ethylenically unsaturated groups, and to a process for production thereof. It further relates to a process for producing a protective layer, and to coated substrates produced thereby, especially films.

There are known processes in which a polymer film is first coated over a large area by means of standard painting methods such as knife-coating, pouring or spraying, and this coating is partly dried until it is virtually tack-free by physical drying or partial curing. This film can then be formed at elevated temperatures and subsequently bonded, insert-molded or insert-foamed. This concept offers a high level of potential for the production, for example, of plastics components, in which case it is possible to replace the more complex step of painting three-dimensional components with the simpler coating of a flat substrate.

In general, good surface properties require a high crosslinking density of the coating. High crosslinking densities, however, lead to thermoset characteristics with maximum possible stretching levels of only a few percent, such that the coating has a tendency to crack during the forming operation. This apparent conflict between the requirement for high crosslinking density and the desire for a high stretching level can be resolved, for example, by conducting the drying/curing of the coating in two steps, before and after the forming operation. An especially suitable method of post-curing is a radiation-induced crosslinking reaction in the coating.

On completion of curing, the coating is supposed to have the properties of a protective layer, meaning that it is supposed to have maximum hardness and scratch resistance, stability to light, water and solvents, and impact resistance. The desired quality in terms of optical and tactile properties is likewise supposed to be assured.

Furthermore, for economically viable employment of this process, the intermediate winding of the coated, formable film onto rolls is necessary. The compressive and thermal stresses which occur in the rolls constitute particular demands on the blocking resistance of the coating which has been applied and dried, but has not yet fully cured.

Thermally formable and subsequently UV-curing coatings are described in the prior art, for example in Beck, Erich (BASF), Scratch resistant UV coatings for automotive applications, Pitture e Vernici, European Coatings (2006), 82(9), 10-19; Beck, Erich, Into the third dimension: three ways to apply UV coating technology to 3D-automotive objects, European Coatings Journal (2006), (4), 32, 34, 36, 38-39; Petzoldt, Joachim; Coloma, Fermín (BMS), New three-dimensionally formable hardcoat films, JOT, Journal fuer OberflaEchentechnik (2010), 50(9), 40-42 and Petzoldt et al., Development of new generation hardcoated films for complex 3D-shaped FIM applications, RadTech Asia 2011, Conference Proceedings.

Most of these are based on what are called macromonomers, which are prepared principally by dual-cure methods. Thermoplastic macromonomers form through a first curing mechanism (e.g. PUR, polyaddition); the groups which cure through UV light and are unaffected thereby (e.g. acrylates), arranged as terminal or lateral substituents, come into effect after the forming in the second curing step. A disadvantage, however, is that such macromonomers themselves, or the components therefor, have to be synthesized specially, which generally causes additional costs in the production. Macromonomers obtainable by dual-cure methods are described, for example, in EP 2 113 527 A1.

WO 2005/080484 A1 describes a radiation-curable composite sheet or film composed of at least one substrate layer and an outer layer comprising a radiation-curable composition having a glass transition temperature below 50° C. with high double bond density.

WO 2005/118689 A1 discloses an analogous composite sheet or film in which the radiation-curable composition additionally contains acid groups. Both applications describe the outer layer as non-tacky; a relatively high blocking resistance, as required, for example, for the rolling of the film around a core, is not achieved. The possibility of winding up the composite films to rolls prior to the radiative curing of the outer layer is therefore not mentioned either.

In the prior art, there is consequently still a need for improved or at least alternative radiation-curing coatings. It would be desirable to have coatings where the coating on films, for example, after forming and curing, exhibits a high abrasion resistance, scratch resistance and solvent resistance with simultaneously good adhesion on the film. In addition, it would be desirable to have improved or at least alternative coatings where the coating, prior to forming, has such a high blocking resistance that the films coated therewith can be rolled up without any problem, but nevertheless allow high stretching levels to be achieved in the forming process. A further important feature relates to the economic viability of such coating systems. Typically, the macromonomers or components thereof are specially synthesized for such coating systems, which naturally causes higher costs in the production. It would therefore additionally be desirable to configure the coating systems so as to be producible in a very simple and efficient manner. Thus, there is a need in the prior art for coating compositions which are firstly simple, efficient and hence favourable to produce, and which secondly lead to coatings, especially on films, which are blocking-resistant after application and drying, and have a high abrasion resistance, scratch resistance and solvent resistance after curing.

The provision of such coating compositions and of substrates coated therewith and having the profile properties described constitutes a particular challenge to the person skilled in the art.

The present invention therefore provides the following: a coating composition comprising
(a) at least one thermoplastic polymer having a mean molar mass Mw of at least 100 000 g/mol in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,
   where the proportion of ethylenically unsaturated groups is at least 3 mol per kg of the solids content of the coating composition.

After application to a substrate, for example a film, and after drying, the inventive coating composition features good blocking resistance, and, after curing by actinic radiation, a likewise good solvent resistance, scratch resistance and abrasion resistance.

Thermoplastic polymers have been found to be particularly advantageous for the final properties of the coating according to the present invention. Thermoplastic polymers in the context of the present invention are, in a preferred embodiment, therefore linear thermoplastic polymers. Preference is given especially to polymethylmethacrylate (PMMA), various kinds of polyester (e.g. PET, PEN, PBTP and UP), other polymers such as rigid PVC, cellulose esters (such as CA, CAB, CP), polystyrene (PS) and copolymers (SAN, SB and MBS), polyacrylonitrile (PAN), ABS polymers, acrylonitrile-methyl methacrylate (AMMA), acrylonitrile-styrene-acrylic ester (ASA), polyurethane (PUR), polyethylene (PE, PE-HD, -LD, -LLD, -C), polypropylene (PP), polyamide (PA), polycarbonate (PC) or polyether sulphone (PES). The abbreviations are defined in DIN 7728T1.

The Vicat softening temperatures VET (ISO 306-650), in a further preferred embodiment of the present invention, are in the region of at least 90° C., preferably at least 95° C., more preferably at least 100° C.

Polymethylmethacrylate is advantageous.

Polymethylmethacrylate (PMMA) is understood to mean especially polymethylmethacrylate homopolymer and methyl methacrylate-based copolymers having a methyl methacrylate content of more than 70% by weight. Such polymethylmethacrylates are obtainable, for example, under the trade names Degalan®, Degacryl®, Plexyglas®, Acrylite® (from Evonik), Altuglas, Oroglas (from Arkema), Elvacite®, Colacryl®, Lucite® (from Lucite), and under names including Acrylglas, Conacryl, Deglas, Diakon, Friacryl, Hesaglas, Limacryl, PerClax and Vitroflex.

In a further advantageous embodiment, preference is given to PMMA homopolymers and/or copolymers of 70% by weight to 99.5% by weight of methyl methacrylate and 0.5% by weight to 30% by weight of methyl acrylate. Particular preference is given to PMMA homopolymers and copolymers of 90% by weight to 99.5% by weight of methyl methacrylate and 0.5% by weight to 10% by weight of methyl acrylate. The Vicat softening temperatures VET (ISO 306) may be in the region of at least 90° C., preferably from ≧100° C. to ≦115° C.

Particular preference is given to PMMA homopolymers and copolymers having a molecular weight Mw of more than 150 000 and most preferably having a molecular weight Mw exceeding 200 000.

The molecular weight Mw can be determined, for example, by gel permeation chromatography or by the scattered light method (see, for example, H. F. Mark et al., Encyclopedia of Polymer Science and Engineering, 2nd edition, vol. 10, pages 1 ff., J. Wiley, 1989).

The polymer is an essential part of the inventive coating composition and of the inventive coating. The proportion of the linear thermoplastic polymer in the solids content of the coating composition is at least 30% by weight. Particular preference is given to 40% by weight, very particular preference to 45% by weight.

Reactive diluents usable with preference as component (b) of the inventive coating composition are bifunctional, trifunctional, tetrafunctional, pentafunctional or hexafunctional acrylic and/or methacrylic monomers. Preference is given to ester functions, especially acrylic ester functions. Suitable polyfunctional acrylic and/or methacrylic esters derive from aliphatic polyhydroxyl compounds having at least 2, preferably at least 3 and more preferably at least 4 hydroxyl groups, and preferably 2 to 12 carbon atoms.

Examples of such aliphatic polyhydroxyl compounds are ethylene glycol, propylene glycol, butane-1,4-diol, hexane-1,6-diol, diethylene glycol, triethylene glycol, glycerol, trimethylolpropane, pentaerythritol, dipentaerythritol, tetramethylolethane and sorbitan. Examples of esters of said polyhydroxyl compounds, said esters being suitable with preference in accordance with the invention as bi- to hexafunctional acrylic and/or methacrylic monomers for the reactive diluent, are glycol diacrylate and dimethacrylate, butanediol diacrylate or dimethacrylate, dimethylolpropane diacrylate or dimethacrylate, diethylene glycol diacrylate or dimethacrylate, divinylbenzene, trimethylolpropane triacrylate or trimethacrylate, glyceryl triacrylate or trimethacrylate, pentaerythrityl tetraacrylate or tetramethacrylate, dipentaerythrityl penta-/hexaacrylate (DPHA), butane-1,2,3,4-tetraol tetraacrylate or tetramethacrylate, tetramethylolethane tetraacrylate or tetramethacrylate, 2,2-dihydroxypropane-1,3-diol tetraacrylate or tetramethacrylate, diurethane dimethacrylate (UDMA), sorbitan tetra-, penta- or hexaacrylate or the corresponding methacrylates. It is also possible to use mixtures of crosslinking monomers having two to four or more ethylenically unsaturated, free-radically polymerizable groups.

Additionally in accordance with the invention, it is possible to use, as reactive diluents or components b) of the inventive coating composition, alkoxylated di-, tri-, tetra-, penta- and hexaacrylates or -methacrylates. Examples of alkoxylated diacrylates or -methacrylates are alkoxylated, preferably ethoxylated, methanediol diacrylate, methanediol dimethacrylate, glyceryl diacrylate, glyceryl dimethacrylate, neopentyl glycol diacrylate, neopentyl glycol dimethacrylate, 2-butyl-2-ethylpropane-1,3-diol diacrylate, 2-butyl-2-ethylpropane-1,3-diol dimethacrylate, trimethylolpropane diacrylate or trimethylolpropane dimethacrylate.

Examples of alkoxylated triacrylates or -methacrylates are alkoxylated, preferably ethoxylated, pentaerythrityl triacrylate, pentaerythrityl trimethacrylate, glyceryl triacrylate, glyceryl trimethacrylate, butane-1,2,4-triol triacrylate, butane-1,2,4-triol trimethacrylate, trimethylolpropane triacrylate, trimethylolpropane trimethacrylate, tricyclodecanedimethanol diacrylate, tricyclodecanedimethanol dimethacrylate, ditrimethylolpropane tetraacrylate or ditrimethylolpropane tetramethacrylate.

Examples of alkoxylated tetra-, penta- or hexaacrylates are alkoxylated, preferably ethoxylated, pentaerythrityl tetraacrylate, dipentaerythrityl tetraacrylate, dipentaerythrityl pentaacrylate, dipentaerythrityl hexaacrylate, pentaerythrityl tetramethacrylate, dipentaerythrityl tetramethacrylate, dipentaerythrityl pentamethacrylate or dipentaerythrityl hexamethacrylate.

In the alkoxylated diacrylates or -methacrylates, triacrylates or -methacrylates, tetraacrylates or -methacrylates, pentaacrylates or -methacrylates and/or alkoxylated hexaacrylates or -methacrylates in component b), all the acrylate groups or methacrylate groups or only some of the acrylate groups or methacrylate groups in the respective monomer may be bonded to the corresponding radical via alkylene oxide groups. It is also possible to use any desired mixtures of such wholly or partly alkoxylated di-, tri-, tetra-, penta- or hexaacrylates or -methacrylates. In this case, it is also possible that the acrylate or methacrylate group(s) is/are bonded to the aliphatic, cycloaliphatic or aromatic radical of the monomer via a plurality of successive alkylene oxide groups, preferably ethylene oxide groups. The mean number of alkylene oxide or ethylene oxide groups in the monomer is stated by the alkoxylation level or ethoxylation level. The alkoxylation level or ethoxylation level may preferably be from 2 to 25, particular preference being given to alkoxylation levels or ethoxylation levels of 2 to 15, most preferably of 3 to 9.

Likewise in accordance with the invention, reactive diluents or components b) of the inventive coating composition may be oligomers which belong to the class of the aliphatic urethane acrylates or of the polyester acrylates or polyacryloylacrylates. The use thereof as paint binders is known and is described in Chemistry & Technology of UV & EB Formulation for Coatings, Inks & Paints, vol. 2, 1991, SITA Technology, London (P. K. T. Oldring (ed.) on p. 73-123 (Urethane Acrylates) and p. 123-135 (Polyester Acrylates). Commercially available examples which are suitable within the inventive context include aliphatic urethane acrylates such as Ebecryl® 4858, Ebecryl® 284, Ebecryl® 265, Ebecryl® 264, Ebecryl® 8465, Ebecryl® 8402 (each manufactured by Cytec Surface Specialities), Craynor® 925 from Cray Valley, Viaktin® 6160 from Vianova Resin, Desmolux VP LS 2265 from Bayer MaterialScience AG, Photomer 6891 from Cognis, or else aliphatic urethane acrylates dissolved in reactive diluents, such as Laromer® 8987 (70% in hexanediol diacrylate) from BASF AG, Desmolux U 680 H (80% in hexanediol diacrylate) from Bayer MaterialScience AG, Craynor® 945B85 (85% in hexanediol diacrylate), Ebecryl® 294/25HD (75% in hexanediol diacrylate), Ebecryl® 8405 (80% in hexanediol diacrylate), Ebecryl® 4820 (65% in hexanediol diacrylate) (each manufactured by Cytec Surface Specialities) and Craynor® 963B80 (80% in hexanediol diacrylate), each from Cray Valley, or else polyester acrylates such as Ebecryl® 810, 830, or polyacryloylacrylates such as Ebecryl®, 740, 745, 767 or 1200 from Cytec Surface Specialities.

In a further preferred embodiment, the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaaacrylates and/or pentamethacrylates, alkoxylated hexaacrylates and/or hexamethacrylates, aliphatic urethane acrylates, polyester acrylates, polyacryloylacrylates and mixtures thereof.

Also in accordance with the invention are mixtures of such crosslinking multifunctional monomers and monofunctional monomers (for example methyl methacrylate). The proportion of the multifunctional monomers in such a mixture should not be below 20% by weight.

Component (b) is an essential part of the inventive coating composition and of the inventive coating. The total proportion of component (b) in the solids content of the coating composition is at least 30% by weight. Particular preference is given to 40% by weight, very particular preference to 45% by weight.

The content of ethylenically unsaturated groups has a significant influence on the achievable durability properties of the radiation-cured coating. Therefore, the inventive coating composition contains a content of ethylenically unsaturated groups of at least 3.0 mol per kg of solids content of the coating composition, preferably at least 3.5 mol per kg, more preferably at least 4.0 mol per kg of solids content of the coating composition. This content of ethylenically unsaturated groups is also well known to the person skilled in the art by the term “double bond density”.

The photoinitiators of the present invention are understood to mean the standard, commercially available compounds, for example α-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacylphosphine oxide and others, said photoinitiators being utilizable alone or in combination of two or more or in combination with one of the above polymerization initiators.

UV photoinitiators used are, for example, the IRGACURE® products from BASF, for example the products IRGACURE® 184, IRGACURE® 500, IRGACURE® 1173, IRGACURE®2959, IRGACURE® 745, IRGACURE® 651, IRGACURE® 369, IRGACURE® 907, IRGACURE® 1000, IRGACURE® 1300, IRGACURE® 819, IRGACURE® 819DW, IRGACURE® 2022, IRGACURE® 2100, IRGACURE® 784, IRGACURE® 250; in addition, the DAROCUR® products from BASF are used, for example the products DAROCUR® MBF, DAROCUR® 1173, DAROCUR® TPO, DAROCUR® 4265. Among other substances, the further UV photoinitiators are used, for example Esacure One (from Lamberti).

Photoinitiators are present in the coating composition at in the range from ≧0.1 to ≦10 parts by weight of the solids content of the coating composition.

The coating composition additionally contains, over and above the solids content of the 100 parts by weight of components a) to c), one or more organic solvents. Such organic solvents may be selected, for example, from the group comprising aromatic solvents, for example xylene or toluene, ketones, for example acetone, 2-butanone, methyl isobutyl ketone, diacetone alcohol, alcohols, for example methanol, ethanol, i-propanol, butanol, 1-methoxy-2-propanol, ethers, for example 1,4-dioxane, ethylene glycol n-propyl ether, or esters, for example ethyl acetate, butyl acetate, 1-methoxy-2-propyl acetate, or mixtures comprising these solvents.

Preference is given to ethanol, i-propanol, butanol, ethyl acetate, butyl acetate, 1-methoxy-2-propanol, diacetone alcohol, xylene or toluene, and mixtures thereof. Particular preference is given to i-propanol, butanol, ethyl acetate, butyl acetate, 1-methoxy-2-propanol, diacetone alcohol and mixtures thereof. Very particular preference is given to 1-methoxy-2-propanol and diacetone alcohol, especially I-methoxy-2-propanol.

The coating composition of the present invention preferably contains, in addition to the solids content with the 100 parts by weight of components a) to c), 0 to 900 parts by weight, more preferably 0 to 850 parts by weight, most preferably 200 to 800 parts by weight, of at least one organic solvent.

The coating composition according to the present invention may additionally optionally contain, over and above the 100 parts by weight of components a) to c), one or more further coatings additives. Such coatings additives may be selected, for example, from the group comprising stabilizers, levelling agents, surface additives, pigments, dyes, inorganic nanoparticles, adhesion promoters, UV absorbers, IR absorbers, preferably from the group comprising stabilizers, levelling agents, surface additives and inorganic nanoparticles. The coating composition of the present invention may contain, in preferred embodiments, in addition to the 100 parts by weight of components a) to c), 0 to 35 parts by weight, more preferably 0 to 30 parts by weight, most preferably 0.1 to 20 parts by weight, of at least one further coatings additive. Preferably, the total proportion of all the coatings additives present in the coating material composition is 0 to 20 parts by weight, more preferably 0 to 10 parts by weight, most preferably 0.1 to 10 parts by weight.

The coating composition may comprise inorganic nanoparticles to increase the mechanical durability, for example scratch resistance and/or pencil hardness.

Useful nanoparticles include inorganic oxides, mixed oxides, hydroxides, sulphates, carbonates, carbides, borides and nitrides of elements of main group II to IV and/or elements of transition group I to VIII of the Periodic Table, including the lanthanides. Preferred nanoparticles are silicon oxide, aluminium oxide, cerium oxide, zirconium oxide, niobium oxide, zinc oxide or titanium oxide nanoparticles, particular preference being given to silicon oxide nanoparticles.

The particles used preferably have mean particle sizes (measured by means of dynamic light scattering in dispersion, determined as the Z-average) of less than 200 nm, preferably of 5 to 100 nm, more preferably 5 to 50 nm. Preferably at least 75%, more preferably at least 90%, even more preferably at least 95%, of all the nanoparticles used have the sizes defined above.

The coating composition can be produced in a simple manner by first of all dissolving the polymer completely in the solvent at room temperature or at elevated temperatures and then the other obligatory and any optional components to the solution which has been cooled to room temperature, either combining them in the absence of solvent(s) and mixing them together by stirring, or in the presence of solvent(s), for example adding them to the solvent(s), and mixing them together by stirring. Preferably, first the photoinitiator is dissolved in the solvent(s) and then the further components are added. This is optionally followed by a purification by means of filtration, preferably by means of fine filtration.

The present invention therefore further provides a process for producing a coating composition, comprising the dissolving of components (a), (b), and (c) in the at least one solvent, with simultaneous dissolution of (a), (b) and (c), or dissolution first of (a) and then dissolution of (b) and/or (c), or separate dissolution of (a), (b) and (c) in at least one solvent and then combination of the solutions.

In a preferred embodiment, first (a) is dissolved while heating in at least one solvent and then (b) and (c) are added thereto.

The inventive coating compositions are accordingly particularly suitable for coating of surfaces of substrates, for example plastics, wood or glass, especially of plastics surfaces. On account of their high transparency, the inventive coatings can especially also be used on transparent polymers, preferably transparent thermoplastics such as polycarbonate, polyacrylate or poly(meth)acrylate, polysulphones, polyesters, thermoplastic polyurethane and polystyrene, and the copolymers and mixtures (blends) thereof. Suitable thermoplastics are, for example, polyacrylates, poly(meth)acrylates (e.g. PMMA; e.g. Plexiglas® from Röhm), cycloolefin copolymers (COC; e.g. Topas® from Ticona; Zenoex® from Nippon Zeon or Apel® from Japan Synthetic Rubber), polysulphones (Ultrason@ from BASF or Udel® from Solvay), polyesters, for example PET or PEN, polycarbonate (PC), polycarbonate/polyester blends, e.g. PC/PET, polycarbonate/polycyclohexylmethanol cyclohexanedicarboxylate (PCCD; Xylecs® from GE), polycarbonate/PBT and mixtures thereof.

Preference is given to using polycarbonates or copolycarbonates, and, more particularly, they are preferably used in the form of a film.

Preference is given to using polycarbonate or copolycarbonate films having a co-extruded layer of poly(meth)acrylate.

The present invention further provides a process for producing a protective layer, comprising the steps of
(i) coating a substrate selected from the group consisting of plastics parts, polymer films, wood, paper and metal surfaces with a coating composition comprising
   (a) at least one thermoplastic polymer having a mean molar mass Mw of at least 100 000 g/mol in a content of at least 30% by weight of the solids content of the coating composition;
   (b) at least one UV-curable reactive diluent in a content of at least 30% by weight of the solids content of the coating composition;
   (c) at least one photoinitiator in a content of ≧0.1 to ≦10 parts by weight of the solids content of the coating composition; and
   (d) at least one organic solvent,
   where the proportion of ethylenically unsaturated groups is at least 3 mol per kg of the solids content of the coating composition;
(ii) drying the coating;
(iii) optionally cutting the substrate to size and/or delaminating, printing and/or thermally or mechanically forming the substrate; and
(iv) irradiating the coating with actinic radiation to cure the coating.

The process is described by way of example hereinafter with regard to the particularly preferred substrate, a film, especially film comprising a thermoplastic polymer such as, more particularly, polycarbonate. The film can be coated with the coating composition by the standard methods for coating films with fluid coating compositions, for example by knife-coating, spraying, pouring, flow-coating, dipping, rolling or spin-coating. The flow-coating process can be effected manually with a hose or suitable coating head, or automatically in a continuous run by means of flow-coating robots and optionally slot dies. Preference is given to the application of the coating composition by a roll-to-roll transfer. In this case, the surface of the film to be coated may be pretreated by cleaning or activation.

The drying follows the application of the coating composition to the film. For this purpose, more particularly, elevated temperatures in ovens, and moving and optionally also dried air, for example in convection ovens or by means of nozzle dryers, and thermal radiation such as IR and/or NIR, are employed. In addition, it is possible to use microwaves. It is possible and advantageous to combine a plurality of these drying processes. The drying of the coating in step (ii) preferably comprises flash-off at room temperature and/or elevated temperature, such as preferably at 20-200° C., more preferably at 40-120° C. After the coating has been dried, it is blocking-resistant, and so the coated substrate, especially the coated film, can be laminated, printed and/or thermally formed. Forming in particular is preferred in this context, since merely the forming of a coated film here can define the mould for a film insert moulding process for production of a three-dimensional plastics part.

Advantageously, the conditions for the drying are selected such that the elevated temperature and/or the thermal radiation does not trigger any polymerization (crosslinking) of the acrylate or methacrylate groups, since this can impair formability. In addition, the maximum temperature attained should appropriately be selected at a sufficiently low level that the film does not deform in an uncontrolled manner.

After the drying/curing step, the coated film, optionally after lamination with a protective film on the coating, can be rolled up. The film can be rolled up without the coating sticking to the reverse side of the substrate film or of the laminating film. However, it is also possible to cut the coated film to size and to send the cut sections individually or as a stack to further processing.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiative curing is preferably effected by the action of high-energy radiation, i.e. UV radiation or daylight, for example light of wavelength≧200 nm to ≦750 nm, or by irradiation with high-energy electrons (electron beams, for example ≧90 keV to ≦300 keV). The radiation sources used for light or UV light are, for example, moderate- or high-pressure mercury vapour lamps, wherein the mercury vapour may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≧80 mJ/cm² to ≦5000 mJ/cm².

In a preferred embodiment, the actinic radiation is therefore light in the UV light range.

The irradiation can optionally be performed with exclusion of oxygen, for example under inert gas atmosphere or reduced-oxygen atmosphere. Suitable inert gases are preferably nitrogen, carbon dioxide, noble gases or combustion gases. In addition, the irradiation can be effected by covering the coating with media transparent to the radiation. Examples thereof are polymer films, glass or liquids such as water.

According to the radiation dose and curing conditions, the type and concentration of any initiator used can be varied or optimized in a manner known to those skilled in the art or by exploratory preliminary tests. For curing of the formed films, it is particularly advantageous to conduct the curing with several emitters, the arrangement of which should be selected such that every point on the coating receives substantially the optimal radiation dose and intensity for curing. More particularly, unirradiated regions (shadow zones) should be avoided.

In addition, according to the film used, it may be advantageous to select the irradiation conditions such that the thermal stress on the film does not become too great. In particular, thin films and films made from materials having a low glass transition temperature can have a tendency to uncontrolled deformation when a particular temperature is exceeded as a result of the irradiation. In these cases, it is advantageous to allow a minimum level of infrared radiation to act on the substrate, by means of suitable filters or a suitable design of the emitters. In addition, reduction of the corresponding radiation dose can counteract uncontrolled deformation. However, it should be noted that a particular dose and intensity in the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. In that case, photoinitiators are used in concentrations of ≧0.1% by weight to ≦10% by weight, more preferably of ≧0.2% by weight to ≦3.0% by weight, based on the solids content of the coating. These coatings are preferably cured using a dose of ≧80 mJ/cm^{Z} to ≦5000 mJ/cm².

The present invention therefore further relates to a coated substrate obtainable by a process comprising the steps of
(i) coating a substrate selected from the group consisting of plastics parts, polymer films, wood, paper and metal surfaces with a coating composition comprising
   (a) at least one thermoplastic polymer having a mean molar mass Mw of at least 100 000 g/mol in a content of at least 30% by weight of the solids content of the coating composition;
   (b) at least one UV-curable reactive diluent in a content of at least 30% by weight of the solids content of the coating composition;
   (c) at least one photoinitiator in a content of ≧0.1 to ≦10 parts by weight of the solids content of the coating composition; and
   (d) at least one organic solvent,
   where the proportion of ethylenically unsaturated groups is at least 3 mol per kg of the solids content of the coating composition;
(ii) drying the coating;
(iii) optionally cutting the substrate to size and/or delaminating, printing and/or thermally or mechanically forming the substrate; and
(iv) irradiating the coating with actinic radiation to cure the coating.

In a preferred embodiment, substrate is a film, especially a polycarbonate film.

The coated surface of the resulting cured, coated and optionally formed film shows very good resistances to solvents, staining liquids as occur in the household, and high hardness, good scratch and abrasion resistances, coupled with high optical transparency.

Such films can be used, for example, for production of shaped bodies having structural elements having very small radii of curvature. After curing, the coatings have good abrasion resistance and chemical resistance.

The film for use in accordance with the invention advantageously has, as well as the general durability required, particularly the necessary thermal formability. Polymers suitable in principle are therefore especially thermoplastic polymers such as ABS, AMMA, ASA, CA, CAB, EP, UF, CF, MF, MPF, PF, PAN, PA, PE, HDPE, LDPE, LLDPE, PC, PET, PMMA, PP, PS, SB, PUR, PVC, RF, SAN, PBT, PPE, POM, PP-EPDM, and UP (abbreviations to DIN 7728T1), and also mixtures thereof, and additionally composite films formed from two or more layers of these polymers. In general, the films for use in accordance with the invention may also comprise reinforcing fibres or fabrics, provided that these do not impair the desired thermoplastic forming.

Particularly suitable are thermoplastic polyurethanes, polymethylmethacrylate (PMMA) and modified variants of PMMA, and additionally polycarbonate (PC), ASA, PET, PP, PP-EPDM and ABS. Among these, preference is given to polycarbonate and the film co-extrudates thereof with polymethylmethacrylate. Very particular preference is given to polycarbonate.

Suitable polycarbonates for the production of the polymer composition for use as a substrate in accordance with the invention are all the known polycarbonates. These are homopolycarbonates, copolycarbonates and thermoplastic polyester carbonates. The suitable polycarbonates preferably have mean molecular weights M̅_{w} of 18 000 to 40 000, preferably of 26 000 to 36 000 and especially of 28 000 to 35 000, determined by measuring the relative solution viscosity in dichloromethane or in mixtures of equal weights of phenol/o-dichlorobenzene, calibrated by light scattering.

The polycarbonates are preferably prepared by the interfacial process or the melt transesterification process, which have been described many times in the literature. With regard to the interfacial process, reference is made by way of example to H. Schnell, Chemistry and Physics of Polycarbonates, Polymer Reviews, vol. 9, Interscience Publishers, New York 1964 S. 33 f., to Polymer Reviews, vol. 10, “Condensation Polymers by Interfacial and Solution Methods”, Paul W. Morgan, Interscience Publishers, New York 1965, ch. VIII, p. 325, to Drs. U. Grigo, K. Kircher and P. R-Müller “Polycarbonate” [Polycarbonates] in Becker/Braun, Kunststoff-Handbuch [Polymer Handbook], volume 3/1, Polycarbonate, Polyacetate, Polyester, Celluloseester [Polycarbonates, Polyacetals, Polyesters, Cellulose Esters], Carl Hanser Publishers, Munich, Vienna, 1992, p. 118-145, and to EP-A 0 517 044. The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and U.S. Pat. No. 6,228,973.

The polycarbonates are obtained from reactions of bisphenol compounds with carbonic acid compounds, especially phosgene, or diphenyl carbonate or dimethyl carbonate in the melt transesterification process. Particular preference is given here to homopolycarbonates based on bisphenol A and copolycarbonates based on monomers bisphenol A and 1,1-bis(4-hydroxyphenyl)-3,3,5-trimethylcyclohexane. Further bisphenol compounds which can be used for the polycarbonate synthesis are disclosed, inter alia, in WO-A 2008037364, EP-A 1 582 549, WO-A 2002026862, WO-A 2005113639

The polycarbonates may be linear or branched. It is also possible to use mixtures of branched and unbranched polycarbonates.

Suitable branching agents for polycarbonates are known from the literature and are described, for example, in patent specifications U.S. Pat. No. 4,185,009, DE-A 25 00 092, DE-A 42 40 313, DE-A 19 943 642, U.S. Pat. No. 5,367,044 and in literature cited therein. Furthermore, the polycarbonates used may also be intrinsically branched, in which case no branching agent is added in the course of polycarbonate preparation. One example of intrinsic branches is that of so-called Fries structures, as disclosed for melt polycarbonates in EP-A 1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

The polymer composition(s) of the substrate layer(s) may additionally comprise additives, for example UV absorbers, IR absorbers and other customary processing aids, especially demoulding agents and fluxes, and also the customary stabilizers, especially thermal stabilizers, and also antistats, pigments, colourants and optical brighteners. In every layer, different additives or concentrations of additives may be present.

The film or else sheet is preferably used in a thickness of ≧10 μm to ≦1500 μm, more preferably of ≧50 μm to ≦1000 μm and especially preferably of ≧200 μm to ≦400 μm. In addition, the film material may comprise additives and/or processing aids for film production, for example stabilizers, light stabilizers, plasticizers, fillers such as fibres, and dyes. The side intended for coating and the other side of the film may be smooth or have a surface structure, preference being given to a smooth surface of the side to be coated.

In one embodiment, the film is a polycarbonate film having a thickness of ≧10 μm to ≦1500 μm. This likewise includes a polycarbonate film having the aforementioned additives and/or processing aids. The thickness of the film may also be ≧50 μm to ≦1000 μm or ≧200 μm to ≦400 μm.

In a further preferred embodiment, the substrate film is a polycarbonate film having a PMMA layer co-extruded from at least one side, the thickness of which is in the range of ≧10 μm and ≦100 μm, preferably in the range of ≧15 μm and ≦60 μm.

The film may be coated on one or both sides, preference being given to single-sided coating. In the case of single-sided coating, a thermally formable adhesive layer may optionally be applied on the reverse side of the film, i.e. on the surface to which the coating composition is not applied. For this purpose, according to the procedure, preferably hotmelt adhesives or radiation-curing adhesives are suitable. In addition, it is also possible to apply a likewise thermally formable protective film on the surface of the adhesive layer. In addition, it is possible to provide the film with backing materials such as fabrics on the reverse side, but these should be formable to the desired degree.

The blocking resistance of the coating is a first, but a very important, property for the film coating, precisely because the films are usually rolled up after coating. According to the size of the roll, the pressure on the surface of the coating may be considerable, particularly close to the winding core. Under this stress, the surface of the dried coating should not be deformed. Customary lamination films which are used industrially in this sector are extruded polyethylene films. These always have a surface structure which should ideally not be embossed into the coating.

Optionally, the film, before or after the application of the radiation-curable layer, may be painted or printed with one or more layers. This can be done on the coated or uncoated side of the film. The layers may be colouring or functional, and may be applied over the full area or only partially, for example as a printed image. The coating materials used should be thermoplastic, in order not to tear in any later forming operation. Printing inks, such as those commercially available for “in-mould decoration” processes, can be used.

In one embodiment, the forming of the film with the dried coating is effected in a mould at a pressure of ≧20 bar to ≦150 bar. Preferably, the pressure in this high-pressure forming process is within a range from ≧50 bar to ≦120 bar or within a range from ≧90 bar to ≦110 bar. The pressure to be applied is determined especially by the thickness of the film to be formed and the temperature, and the film material used.

In a further embodiment, the forming takes place at a temperature of ≧20° C. to ≦60° C. below the softening temperature of the film material. Preferably, this temperature is ≧30° C. to ≦50° C. or ≧40° C. to ≦45° C. below the softening temperature. This method, which is comparable to cold forming, has the advantage that it is possible to use comparatively thin films, which lead to more exact moulding. A further advantage is shorter cycle times and lower thermal stress on the coating. Such forming temperatures are advantageously used in combination with a high-pressure forming process.

The present invention further relates to the use of coated films according to the invention for production of shaped bodies, such as, more particularly, in film insert moulding processes as known in the prior art. The coated films produced in accordance with the invention are valuable materials for production of everyday articles. For instance, the coated film may find use in the production of installable motor vehicle components, plastics parts such as facings for motor vehicle (interior) construction and/or aircraft (interior) construction, furniture making, electronic devices, communication devices, housings and decorative articles. The present invention therefore also relates to the use of the inventive coated films and likewise of the inventive coating composition in the production of installable motor vehicle components, plastics parts such as facings for motor vehicle (interior) construction and/or aircraft (interior) construction, furniture making, electronic devices, communication devices, housings and decorative articles.

In a further preferred embodiment of the coated substrate, especially of the coated film, preferably of the coated polycarbonate film, the process comprises a further step (v): insert-moulding the coated substrate, especially the coated polycarbonate film, with at least one polymer on the uncoated side of the polycarbonate film. Useful polymers here are all the polymers mentioned above. In this way, it is possible in a very efficient manner to obtain shaped bodies having the advantageous coated surface of the invention. This is very advantageous for the abovementioned applications of the coated film.

### EXAMPLES

### Assessment Methods

Assessment of Blocking Resistance

Conventional test methods as described, for instance, in DIN 51350 are insufficient to simulate the blocking resistance of rolled-up, pre-dried, coated films, and therefore the following test was employed: The coating materials were applied to Makrofol DE 1-1 (375 μm) with a conventional coating bar (target wet film thickness 100 μm). After a flash-off phase at 20° C. to 25° C. for 10 min, the coated films were dried in an air circulation oven at 110° C. for 10 min. After a cooling phase for 1 min, a commercial GH-X173 natur pressure-sensitive lamination film (from Bischof und Klein, Lengerich, Germany) was applied without creasing to the dried coated film with a plastic roller over an area of 100 mm×100 mm. Subsequently, the laminated film piece was subjected to a weight of 10 kg over the full area for 1 hour. Thereafter, the lamination film was removed and the coated surface was assessed visually.

Assessment of Pencil Hardness

The pencil hardness was measured analogously to ASTM D 3363 using an Elcometer 3086 Scratch boy (Elcometer Instruments GmbH, Aalen, Germany) under a load of 500 g, unless stated otherwise.

Assessment of Steel Wool Scratching

The steel wool scratching is determined by sticking a piece of No. 00 steel wool (Oskar Weil GmbH Rakso, Lahr, Germany) onto the flat end of a 500 g fitter's hammer, the area of the hammer being 2.5 cm×2.5 cm, i.e. approximately 6.25 cm². The hammer is placed onto the surface to be tested without applying additional pressure, such that a defined load of about 560 g is attained. The hammer is then moved back and forth 10 times in twin strokes. Subsequently, the stressed surface is cleaned with a soft cloth to remove fabric residues and coating particles. The scratching is characterized by haze and gloss values, measured transverse to the scratching direction, with a Micro HAZE plus (20° gloss and haze; Byk-Gardner GmbH, Geretsried, Germany). The measurement is effected before and after scratching. The differential values for gloss and haze before and after stress are reported as Δgloss and Δhaze.

Assessment of Solvent Resistance

The solvent resistance of the coatings was typically tested with isopropanol, xylene, 1-methoxy-2-propyl acetate, ethyl acetate, acetone, in technical-grade quality. The solvents were applied to the coating with a soaked cotton bud and protected from vaporization by covering. Unless stated otherwise, a contact time of 60 minutes at about 23° C. was observed. After the end of the contact time, the cotton bud is removed and the test surface is wiped clean with a soft cloth. The inspection is immediately effected visually and after gentle scratching with a fingernail.

A distinction is made between the following levels:
0=unchanged; no change visible; cannot be damaged by scratching.
1=slight swelling visible, but cannot be damaged by scratching.
2=change clearly visible, can barely be damaged by scratching.
3=noticeable change, surface destroyed after firm fingernail pressure.
4=significant change, scratched through to the substrate after firm fingernail pressure.
5=destroyed; the coating is already destroyed when the chemical is wiped away; the test
substance cannot be removed (has eaten into the surface).

Within this assessment, the test is typically passed with the ratings of 0 and 1. Ratings of >1 represent a “fail”.

### Example 1

### Production of Coating Composition

In a 15 l tank, Degacryl MW 730 (copolymer based on PMMA, M_{w}=10⁶; from Evonik) was dissolved in 1-methoxy-2-propanol at 100° C. (internal temperature) as follows: 4500 g of 1-methoxy-2-propanol (2a) were initially charged and 1100 g of Degacryl MW 730 (1) were introduced while stirring. They were rinsed in with 2500 g of 1-methoxy-2-propanol (2b). The dissolving operation took about 4 hours. In this way, a homogeneous, clear, colourless and viscous composition was obtained. After the dissolving operation, the mixture was cooled to room temperature. 1100 g of dipentaerythrityl penta-/hexaacrylate (DPHA from Cytec) were diluted separately with 2500 g of 1-methoxy-2-propanol. At room temperature, this solution was added to the apparatus and mixed in for 2 hours. 44.0 g of Irgacure 1000 (BASF), 22.0 g of Darocure 4265 (BASF) and 5.5 g of BYK 333 (from BYK) were diluted separately with 400 g of 1-methoxy-2-propanol. On attainment of homogeneity of this solution, it was added to the apparatus and mixed in thoroughly. The mixture was subsequently stirred with exclusion of light for about 6 hours. Yield: 11 363 g. The coating composition had a solids content of 17% and a viscosity (23° C.) of 9000 mPas. In the solids content of the coating composition, the proportion of the high polymer, and likewise the proportion of the reactive diluent, were each 48.4% by weight. The content of the ethylenically unsaturated groups per kg of solids content of the coating composition was about 5.2 mol.

The composition of the further coating compositions can be found in tables 1 and 2.

### Example 2

### Coating of Films

The coating composition according to example 1 is applied to the carrier film, for example Makrofol DE 1-1 (Bayer MaterialScience AG, Leverkusen, Germany), by means of a slot coater from “TSE Troller AG”.

Typical application conditions are as follows:
web speed 1.3 to 2.0 m/min
wet coating applied 100-150 μm
air circulation dryer 90-110° C., preferably in the region of the TG of the polymer to be dried.
residence time in the dryer 3.5-5 min.

The coating is effected roll to roll, meaning that the polycarbonate film is unrolled in the coating system. The film is conducted through one of the abovementioned application units and contacted with the coating solution. Thereafter, the film with the wet coating is run through the dryer. After leaving the dryer, the now dry coating is typically provided with a lamination film, in order to protect it from soiling and scratching. Thereafter, the film is rolled up again.

### Example 3

### Determination of Blocking Resistance

The coated side of the film produced in Example 2 was covered with a lamination film of the GH-X 173 A type (Bischof+Klein, Lengerich, Germany) and weighted down with an aluminium sheet of dimensions 4.5×4.5 cm² and a weight of 2 kg at about 23° C. for 1 h, Thereafter, the weight and the lamination film were removed and the surface of the coating was checked visually for changes.

For the determination of the blocking resistance, the formulations listed in Table 1 were used. The basis was commercially available polymethylmethacrylate binders, which were formulated with a reactive diluent, photoinitiators and customary additives to give a coating solution, which was then applied to a polycarbonate film and physically dried.

TABLE 1
Dependence of blocking resistance on the molecular weight of PMMA

| | | MW *) | 1 | 2 | 3 | 4 | 5 | 6 | 7 |
|---|---|---|---|---|---|---|---|---|---|
| Degalan M825 | 1) | 80 000 | 23.77 | | | | | | |
| Degalan M345 | 1) | 180 000 | | 19.01 | | | | | |
| Degalan M920 | 1) | 300 000 | | | 10.45 | | | | |
| Degacryl | 1) | 500 000 | | | | 11.88 | | | |
| M547 | | | | | | | | | |
| Degacryl | 1) | 700 000 | | | | | 10.93 | | |
| M727 | | | | | | | | | |
| Degacryl | 1) | 1 000 000 | | | | | | 9.00 | |
| MW730 | | | | | | | | | |
| Degacryl 6962 F | 1) | 1 250 000 | | | | | | | 7.61 |
| 1-methoxy-2- | | | 49.98 | 60.00 | 78.01 | 75.00 | 77.00 | 81.06 | 84.00 |
| propanol | | | | | | | | | |
| DPHA **) | 2) | | 23.77 | 19.01 | 10.45 | 11.88 | 10.93 | 9.00 | 7.61 |
| Irgacure 1000 | 3) | | 1.90 | 1.52 | 0.84 | 0.95 | 0.87 | 0.72 | 0.61 |
| Darocur 4265 | 3) | | 0.48 | 0.38 | 0.21 | 0.24 | 0.22 | 0.18 | 0.15 |
| Byk 333 | 4) | | 0.10 | 0.08 | 0.04 | 0.05 | 0.04 | 0.04 | 0.02 |
| Blocking | | | indented | OK | OK | OK | OK | OK | OK |
| resistance | | | | | | | | | |

1) Evonik Industries, Darmstadt, Germany.
2) DSM-AGI Corp., Taipei, Taiwan
3) BASF AG, Ludwigshafen, Germany
4) Byk Additives & Instruments, Wesel, Germany
*) molecular weight as weight average M_{w} as stated by manufacturer
**) dipentaerythrityl hexaacrylate

The composition of entry no. 1 in Table 1 does not correspond to the invention and serves as a comparative example. The experiments in Table 1 thus show that the inventive coatings are blocking-resistant from a molecular weight of the polymethylmethacrylate of 100 000 or more.

### Example 4

### Curing or the Coatings, Testing of the Surfaces

The HPF forming tests were performed on an SAMK 360 system (manufacturer: HDVF Kunststoffmaschinen GmbH). The mould was electrically heated to 100° C. The film heating was undertaken by means of IR emitters at 240-260-280° C. The heating time was 16 seconds. A film temperature of about 170° C. was attained. The forming was effected at a forming pressure of 100 bar. The forming mould was a heating/ventilation panel.

The film sheet was fixed at an exact position on a pallet. The pallet passed through the forming station into the heating zone and resided therein for the time set (16 s). In the course of this, the film was heated in such a way that the film briefly experienced a temperature above the softening point; the core of the film was about 10-20° C. colder. As a result, the film was relatively stable when it was run into the forming station.

In the forming station, the film was fixed by closing the mould over the actual mould; at the same time, the film was formed over the mould by means of gas pressure. The pressure hold time of 7 s ensured that the film was accurately formed by the mould. After the hold time, the gas pressure was released again. The mould opened and the formed film was run out of the forming station.

The film was subsequently removed from the pallet and could then be cured with UV light.

With the mould used, radii down to 1 mm were formed.

The UV curing of the inventive coating was executed with an evo 7 dr high-pressure mercury lamp (ssr engineering GmbH, Lippstadt, Germany). The system was equipped with dichroitic reflectors and quartz discs, and had a specific power of 160 W/cm. A UV dose of 2.0 J/cm² and an intensity of 1.4 W/cm² were applied. The surface temperature was to reach >60° C.

The UV dose figures were determined with a Lightbug ILT 490 (International Light Technologies Inc., Peabody Mass., USA). The surface temperature figures were determined with temperature test strips of the RS brand (catalogue number 285-936; RS Components GmbH, Bad Hersfeld, Germany).

The results for the durability of the coatings which have been crosslinked using the conditions specified can be found in Table 2.

Table 2 summarizes the tests in terms of the variation of the molecular weight of the PMMA and the crosslinking density, represented by the double bond density of the coating formulation. The experiments or compositions of entries 1 to 5 in the table are not in accordance with the present invention and serve as comparative examples.

TABLE 2
Dependence of durability on the molecular weight of the PMMA and on the proportion of the reactive diluent

| | 1 | 2 | 3 | 4 | 5 | 6 | 7 | 8 | 9 | 10 | 11 |
|---|---|---|---|---|---|---|---|---|---|---|---|
| Product | Poly- | Degalan | DBD 3 **) | DBD 4 | DBD 5.2 | DBD 3 | DBD 4 | DBD 5.2 | DBD 3 | DBD 4 | DBD 5.2 |
| | carbonate | M825, | | | | | | | | | |
| | film, | uncross- | | | | | | | | | |
| | Makrofol | linked | | | | | | | | | |
| | DE 1-1 | | | | | | | | | | |
| Degalan M825 | — | — | 27.72 | 26.77 | 23.77 | | | | | | |
| Degalan M345 | — | — | | | | 24.00 | 20.84 | 19.01 | | | |
| Degalan M920 | — | — | | | | | | | 11.73 | 11.89 | 10.45 |
| Degacryl M547 | — | — | | | | | | | | | |
| Degacryl M727 | — | — | | | | | | | | | |
| Degacryl | — | — | | | | | | | | | |
| MW730 | | | | | | | | | | | |
| Degacryl | — | — | | | | | | | | | |
| 6962 F | | | | | | | | | | | |
| 1-methoxy-2- | — | — | 60.00 | 55.00 | 49.98 | 65.34 | 64.98 | 60.00 | 87.96 | 80.00 | 78.01 |
| propanol | | | | | | | | | | | |
| DPHA | — | — | 11.09 | 16.49 | 23.77 | 9.63 | 12.86 | 19.01 | 4.71 | 7.34 | 10.45 |
| Irgacure 1000 | — | — | 0.89 | 1.32 | 1.90 | 0.77 | 1.03 | 1.52 | 0.38 | 0.59 | 0.84 |
| Darocure 4265 | | | 0.22 | 0.33 | 0.48 | 0.19 | 0.26 | 0.38 | 0.09 | 0.15 | 0.21 |
| Byk 333 | — | — | 0.08 | 0.09 | 0.10 | 0.07 | 0.03 | 0.08 | 0.03 | 0.04 | 0.04 |
| Solvent | 5/5/5/5/5 | 4/4/5/5/5 | 1/4/4/5/5 | 0/0/0/1/5 | 0/0/0/0/0 | 0/0/0/0/1 | 0/0/0/0/0 | 0/0/0/0/0 | 0/0/0/0/0 | 0/0/0/0/1 | 0/0/0/0/0 |
| resistance | | | | | | | | | | | |
| IP/X/MPA/ | | | | | | | | | | | |
| EA/Ac *) | | | | | | | | | | | |
| Steel wool | 100/280 | 120/230 | 72/285 | 32/153 | 3/193 | 25/121 | 6/5 | 6/13 | 27/130 | 3/5 | 2/12 |
| scratching | | | | | | | | | | | |
| Δgloss/Δhaze | | | | | | | | | | | |
| Pencil hardness | 4B | HB | H | H | H | H | H | H | H | H | H |

| | 12 | 13 | 14 | 15 | 16 | 17 | 18 | 19 | 20 | 21 |
|---|---|---|---|---|---|---|---|---|---|---|
| Product | DBD 4.5 | DBD 5.2 | DBD 4.5 | DBD 5.2 | DBD 3 | DBD 4 | DBD 4.5 | DBD 5.2 | DBD 4.5 | DBD 5.2 |
| Degalan M825 | | | | | | | | | | |
| Degalan M345 | | | | | | | | | | |
| Degalan M920 | | | | | | | | | | |
| Degacryl M547 | 12.02 | 11.88 | | | | | | | | |
| Degacryl M727 | | | 11.48 | 10.93 | | | | | | |
| Degacryl MW730 | | | | | 10.39 | 8.92 | 9.01 | 9.00 | | |
| Degacryl 6962 F | | | | | | | | | 8.20 | 7.61 |
| 1-methoxy-2-propanol | 78.00 | 75.00 | 79.01 | 49.98 | 85.01 | 85.00 | 83.50 | 81.06 | 85.01 | 84.00 |
| DPHA | 9.04 | 11.88 | 8.63 | 10.93 | 4.16 | 5.50 | 6.78 | 9.00 | 6.17 | 7.61 |
| Irgacure 1000 | 0.72 | 0.95 | 0.69 | 0.87 | 0.33 | 0.44 | 0.54 | 0.72 | 0.49 | 0.61 |
| Darocur 4265 | 0.18 | 0.24 | 0.17 | 0.22 | 0.08 | 0.11 | 0.14 | 0.18 | 0.12 | 0.15 |
| Byk 333 | 0.04 | 0.05 | 0.02 | 0.04 | 0.03 | 0.03 | 0.03 | 0.04 | 0.01 | 0.02 |
| Solvent resistance | 0/0/0/0/1 | 0/0/0/0/0 | 0/0/0/0/1 | 0/0/0/0/0 | 0/0/0/0/5 | 0/0/0/0/1 | 0/0/0/0/1 | 0/0/0/0/0 | 0/0/0/0/1 | 0/0/0/0/0 |
| IP/X/MPA/EA/Ac | | | | | | | | | | |
| Steel wool scratching | 1/1 | 1/2 | 7/3 | 2/1 | 47/196 | 3/8 | 5/11 | 5/5 | 8/14 | 5/3 |
| Δgloss/Δhaze | | | | | | | | | | |
| Pencil hardness | H | H | H | H | H | H | H | H | H | H |

*) isopropanol/xylene/1-methoxy-2-propyl acetate/ethyl acetate/acetone.
**) double bond density (DBD) in mol of double bonds per kg of solid resin

Table 2 shows that the crosslinking of the PMMA already brings about a distinct improvement in solvent resistance and steel wool scratching compared to uncrosslinked PMMA (columns 2-5).

With a low molecular weight, however, the required scratch resistance is not yet achieved even at high crosslinking density (column 5).

Only an increase in the molar mass to 100 000 g/mol or more leads to clearly good values in resistance to solvent and scratching (columns 6 ff.). The control experiment in column 16, however, shows that a double bond density (DBD) of 4 or higher is necessary, even in the case of high molecular weight, to achieve a very good level in solvent resistance and scratch resistance.

### Example 5

### Insert Moulding of the Coated Films

The experiments were conducted on an Arburg Allrounder 560 C 2000-675/350 injection moulding machine. The machine has a screw diameter of 45 mm, and the mould used was the Bayer heating/ventilation panel. For the insert moulding material, a Makrolon 2405 (transparent) from the manufacturer Bayer MaterialScience AG has been used.

The three-dimensionally (3D) formed, transparent films were subjected to insert moulding with Makrolon (polycarbonate, Bayer) having a melt temperature of 280° C. The fill time for filling of the mould was 2 sec. The mould temperature was varied. It was possible to achieve good results with a mould temperature in the range of ≧80° C. and ≦100° C. There was no visually apparent adverse effect in this regard. The hold pressure time was 12 sec and the cooling time was 20 sec.

Some of the films had also been printed on the reverse beforehand with a black screen-printing ink. For this purpose, a special ink from Pröll, Noriphan HTR, was used. Noriphan HTR has been developed specially for the insert moulding of films and has been used since 1997. The printing on the reverse can firstly produce decoration on the film; secondly, the ink also serves as an adhesion promoter for insert moulding with PC/ABS materials. In this case, the films were subjected to insert moulding with a Bayblend T 65 XF (Bayer).

The experiments showed that the formed films can be processed without difficulty in an insert moulding operation with various materials, without any damage to the hardcoat layer.

It has been shown that coatings according to the present invention can achieve an excellent combination of scratch resistance, solvent resistance and pencil hardness. Particular mention should be made of the solvent resistance. Acetone, the most aggressive solvent for coated Makrofol, has almost no effect on the inventive final coating even after contact times of one hour (ratings in Table 2 of ≦1). This means that the solvent resistance, and also the given stability to many other chemical products such as creams, sunscreen oils and the like, for these coatings is at the level of the best hardcoats commercially available at present. Furthermore, the coatings on films are already sufficiently blocking-resistant after drying, such that films coated with the inventive coating composition can be rolled up or thermally formed after the coating has been dried. This property, in combination with the scratch-resistant, abrasion-resistant and solvent-resistant surface obtained after curing in the inventive coatings, makes the inventive coating composition and thermoplastic films coated therewith particularly suitable for use in the production of mouldings in film insert moulding processes.

1.-15. (canceled)

16. A coating composition comprising
(a) at least one thermoplastic polymer having a mean molar mass Mw of at least 100 000 g/mol in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,
wherein the proportion of ethylenically unsaturated groups is at least 3 mol per kg of the solids content of the coating composition.

17. The coating composition as claimed in claim 16, wherein the at least one thermoplastic polymer has a Vicat softening temperature VET to ISO 306 of at least 90° C.

18. The coating composition as claimed in claim 16, wherein the at least one thermoplastic polymer is selected from the group consisting of polymethylmethacrylate, polyesters such as, more particularly, polybutylene terephthalate, polyethylene naphthalate, polybutylene terephthalate, unsaturated polyester resins, rigid PVC, cellulose esters such as CA, CAB, CP, polystyrene and copolymers such as SAN, SB and MBS, polyacrylonitrile (PAN), ABS polymers, acrylonitrile-methyl methacrylate (AMMA), acrylonitrile-styrene-acrylic ester (ASA), polyurethane (PUR), polyethylene (PE, PE-HD, -LD, -LLD, -C), polypropylene (PP), polyamide (PA), polycarbonate (PC) or polyether sulphone (PES).

19. The coating composition as claimed in claim 18, wherein the thermoplastic polymer comprises PMMA homopolymers and/or copolymers of 70% by weight to 99.5% by weight of methyl methacrylate and 0.5% by weight to 30% by weight of methyl acrylate.

20. The coating composition as claimed in claim 16, wherein the reactive diluent (b) comprises bifunctional, trifunctional, tetrafunctional, pentafunctional or hexafunctional acrylic and/or methacrylic monomers.

21. The coating composition as claimed in claim 16, wherein component (b) comprises alkoxylated diacrylates and/or dimethacrylates, alkoxylated triacrylates and/or trimethacrylates, alkoxylated tetraacrylates and/or tetramethacrylates, alkoxylated pentaaacrylates and/or pentamethacrylates, alkoxylated hexaacrylates and/or hexamethacrylates, aliphatic urethane acrylates, polyester acrylates, polyacryloylacrylates and mixtures thereof.

22. The coating composition as claimed in claim 16, wherein the solvent is selected from the group consisting of ethanol, i-propanol, butanol, ethyl acetate, butyl acetate, 1-methoxy-2-propanol, diacetone alcohol, xylene, toluene, and mixtures thereof.

23. A process for producing a coating composition, comprising dissolving components (a), (b), and (c) in the at least one solvent, with simultaneous dissolution of (a), (b) and (c), or dissolution first of (a) and then dissolution of (b) and/or (c), or separate dissolution of (a), (b) and (c) in at least one solvent and then combination of the solutions.

24. The process as claimed in claim 23, wherein first (a) is dissolved while heating in at least one solvent and then (b) and (c) are added thereto.

25. A process for producing a protective layer, comprising the steps of
(i) coating a substrate selected from the group consisting of plastics parts, polymer films, wood, paper and metal surfaces with a composition comprising
(a) at least one thermoplastic polymer having a mean molar mass Mw of at least 100 000 g/mol in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,
wherein the proportion of ethylenically unsaturated groups is at least 3 mol per kg of the solids content of the coating composition;
(ii) drying the coating;
(iii) optionally cutting the substrate to size and/or delaminating, printing and/or thermally or mechanically forming the substrate;
(iv) irradiating the coating with actinic radiation to cure the coating.

26. The process as claimed in claim 25, wherein the actinic radiation is light in the UV range.

27. The process as claimed in claim 25, wherein the reactive diluent (b) comprises bifunctional, trifunctional, tetrafunctional, pentafunctional or hexafunctional acrylic and/or methacrylic monomers.

28. A coated substrate obtained by a process comprising the steps of
(i) coating a substrate with a composition comprising
(a) at least one thermoplastic polymer having a mean molar mass Mw of at least 100 000 g/mol in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,
wherein the proportion of ethylenically unsaturated groups is at least 3 mol per kg of the solids content of the coating composition;
(ii) drying the coating;
(iii) optionally cutting the substrate to size and/or delaminating, printing and/or thermally or mechanically forming the substrate; and
(iv) irradiating the coating with actinic radiation to cure the coating.

29. The coated substrate as claimed in claim 28, wherein the substrate comprises a film.

30. The coated substrate as claimed in claim 28, wherein the substrate comprises a polycarbonate film or a coextruded film of polycarbonate and polymethylmethacrylate.
